(19) United States
(12) Patent Application Publication
(10) Pub. No.: US 2009/0256001 A1
(43) Pub. Date: Oct. 15, 2009

(54) Dispenser

(75) Inventors: Dong Ik Shin, Suwon-si (KR); Hyun Jun Kim, Suwon-si (KR); Seok Cheon Lee, Suwon-si (KR); Sun Ok Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/219,310

(22) Filed: Jul. 18, 2008

(30) Foreign Application Priority Data
Apr. 15, 2008 (KR) 10-2008-0034560

(51) Int. Cl. B05B 15/02

(52) U.S. Cl. 239/106

(57) ABSTRACT

The present invention relates to a dispenser used for fabricating a wafer lens.

The dispenser of the present invention includes: a dispenser body charged with a fluid resin therein; a needle coupled to a bottom part of the dispenser body with a nozzle mounted on an end of a pipe extending to a lower part thereof; and a dispenser case that includes an air inlet and an air outlet in a lower part a circumference surface and a bottom part of the dispenser body, and is mounted with covering the dispenser. The dispenser has a merit that a discharge amount error of the fluid resin can be reduced and an accurate amount of resin can be always discharged.

### CROSS-REFERENCE TO RELATED APPLICATIONS

This application claims the benefit of Korean Patent Application No. 10-2008-0034560 filed with the Korea Intellectual Property Office on Apr. 15, 2008, the disclosure of which is incorporated herein by reference.

### BACKGROUND OF THE INVENTION

1. Field of the Invention

The present invention relates to a dispenser; and more particularly, to a dispenser which allows fixed volume of liquid to be discharged removing remnants of a liquid resin on a nozzle edge by installing an air inlet in a lower part of a dispenser body through which a resin for manufacturing a wafer lens is discharged.

2. Description of the Related Art

Generally, a plenty of wafer lenses are manufactured in a single lens on a wafer by using a mastering process, a stamping process, an embossing process, and a dicing process.

In the mastering process, the lenses are bonded to a wafer substrate by injecting a polymer cured by UV into a mold core and curing the polymer.

The wafer lenses manufactured through the manufacturing process is managed based on a strict standard tolerance of several micrometers less in each step so as to maintain design resolution. Therefore, in the mastering process, since each lens is manufactured in an array form, an error is valid until a final product is manufactured through the following process when the error occurs. Accordingly, the standard tolerance should be more strictly managed.

At this time, a dispenser with the polymer is used to inject the polymer into the mold core, and since the polymer injected into the mold core through the dispenser should be managed to have a discharge amount of 10 micrograms or less, polymer dregs remaining on a needle of the dispenser after the discharge have a bad influence on a manufacturing result.

In the mastering process, first, a fixed quantity of polymer is discharged to a center of a mold through the needle provided in a bottom part of the dispenser.

Herein, since a depth of the mode is in the range of tens to hundreds micrometers and a thickness of the polymer hung on an edge of the needle is approximately in the range of 50 to 100 micrometers, the polymer discharging needle should match the center of the mold. In case that a polymer discharging hole of the needle does not match the center of the mold, the edge of the needle is in contact with a polymer injection surface of the mold. Therefore, there is a high possibility that scratches will occur on the polymer injection surface and there is a problem that an optical surface of the lens may be slanted after manufacturing the lens.

A polymer liquid of tens to hundreds micrograms for manufacturing the lens is leaked through the discharging edge of the needle formed at an edge of the dispenser by polymer liquid's weights. A part of the polymer liquid may be cured and the polymer liquid in addition to the leaked liquid may go up on a side surface of the needle by tension.

In order to prevent the polymer liquid from being leaked, a dispenser capable of controlling a discharge amount by being equipped with mechanical stoppers in the needle and an inside of the dispenser in which the needle is formed has been developed, but the dispenser should use an expensive needle with the stopper.

Since the flow of the polymer liquid charged within the dispenser should be forcibly controlled, there is a problem that a discharge pressure of the polymer liquid discharged from the dispenser becomes uneven.

### SUMMARY OF THE INVENTION

Accordingly, the present invention is made in order to solve the above-described demerits and problems occurring in a conventional dispenser. An advantage of the present invention is to provide a dispenser capable of discharging a precise amount of semi-spherical fluid resin through an end of a nozzle by removing leaking dregs of the fluid resin leaking from a dispenser body charged with the fluid resin through the nozzle by air pressure.

The advantage of the present invention is achieved by providing a dispenser including a dispenser body charged with a fluid resin therein; a needle coupled to a bottom part of the dispenser body with a nozzle mounted on an end of a pipe extending to a lower part thereof; and a dispenser case that includes an air inlet and an air outlet in a lower part and a bottom part of a circumference surface, and is mounted with covering the dispenser.

The dispenser body includes a resin charging unit which has a syringe shape and is a space charged with the fluid resin in a center portion thereof.

A fluid polymer used mainly for fabricating a wafer lens is charged in the resin charging unit. The fluid resin of a predetermined amount is discharged outside of the dispenser by predetermined pressure applied to the resin charging unit.

The needle for discharging the fluid resin of the predetermined amount outside of the dispenser is coupled in the bottom part of the dispenser body. A narrow pipe extends to a lower part of the needle and the nozzle is mounted on an end of the pipe.

Meanwhile, the dispenser case is tightly coupled to an outer circumference surface of the dispenser. An air inlet for receiving air from the outside is provided in a lower part of a circumference surface of the dispenser body and an air outlet is provided in a bottom part of the dispenser body.

At this time, the dispenser case is coupled to the dispenser body and the needle with covering the dispenser body and the needle. The pipe extending to the lower part of the needle is penetratively coupled to the dispenser case through the air outlet formed on a bottom part of the dispenser case.

Therefore, dregs of the fluid resin remaining on the nozzle mounted on the end of the pipe is removed by discharging the air injected through the air inlet of the dispenser case by predetermined air pressure through the air outlet.

### BRIEF DESCRIPTION OF THE DRAWINGS

These and/or other aspects and advantages of a dispenser for fabricating a wafer lens in accordance with the present invention will become apparent and more readily appreciated from the following description of the embodiments, taken in conjunction with the accompanying drawings of which:

FIG. 1 is a side view of a discharge state of a fluid resin using a dispenser; and

FIG. 2 is a cross-sectional view of a dispenser in accordance with the invention.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

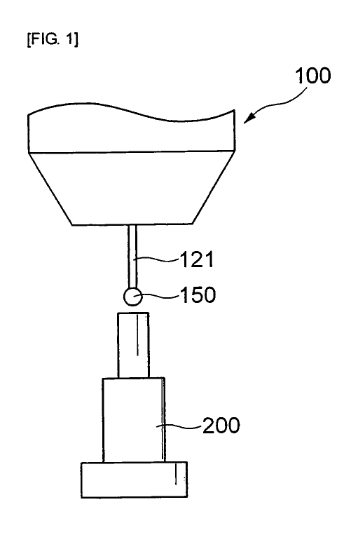

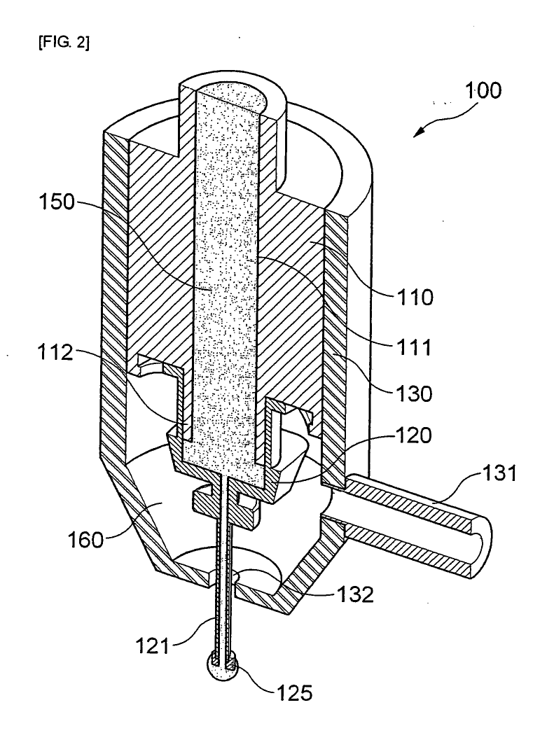

First, FIG. 1 is a side view of a discharge state of a fluid resin using a dispenser and FIG. 2 is a cross-sectional view of a dispenser in accordance with the invention.

As shown in the figure, a dispenser 100 in accordance with an embodiment of the invention includes a dispenser body 110, a needle 120 coupled to the dispenser body 110, and a dispenser case 130 is coupled to the dispenser body 110 and the needle 120 with covering the dispenser body 110 and the needle 120.

As shown in FIG. 1, the dispenser 100 discharges a fluid resin 150 through an end of a pipe 121 of the needle 120 protruding at an end side of the dispenser 100. The fluid resin 150 discharged through the needle 120 is injected into a processing surface (not shown) formed in a mold 200 and thus the fluid resin 150 is injection-molded through the mold 200.

The fluid resin 150 discharged through the dispenser 100 is positioned in a center portion of the processing surface of the mold 200, so that the liquid resin 150 of a predetermined amount is discharged. At this time, the fluid resin 150 of the predetermined amount should be always discharged from the end of the needle pipe 121.

The dispenser body 110 adopted for the dispenser 100 in accordance with the embodiment of the invention shown in FIG. 2 includes a resin charging unit 111 which has a general syringe shape and is a space charged with the fluid resin is formed in an internal center of the dispenser body 110 and the fluid resin 150 for manufacturing an injection molding or a lens is injected into the resin charging unit 111.

The fluid resin 150 is made mainly of fluid silicon or resin, a polymer, or the like as a material of the injection molding and is discharged outside of the dispenser body 110 by a predetermined pressure applied by the resin charging unit 111 of the dispenser body 110.

The needle 120 for discharging the fluid resin 150 is coupled to a bottom part of the dispenser body 110. The needle 120 is firmly coupled to the bottom part of the dispenser body 110 with a coupling end 112 extending to the bottom part of the dispenser body 110 inserted into an inside of the needle 120.

A comparatively narrow pipe 121 having a diameter of approximately 100 μm is extensively formed in a bottom of the needle 120. A nozzle 125 is coupled to an end of the pipe 121.

The needle 120 serves to discharge the fluid resin 150 injected into the resin charging unit 111 of the dispenser body 110 to the outside through the pipe 121. Since a pipe 121 much narrower and comparatively longer than the resin charging unit 111 is formed, the fluid resin 150 is discharged through the nozzle 125 mounted on the end of the pipe 121 in a predetermined amount by pressure control of the fluid resin 150 injected into the resin charging unit 111.

Meanwhile, the dispenser case 130 having an air inlet 131 and an air outlet 132 is mounted on outsides of the dispenser body 110 and the needle 120.

At this time, an air charged space 160 is formed in an inner lower part with an inner circumference surface of the dispenser case 130 being in close contact with an outer circumference surface of the dispenser body 110.

The air inlet 131 formed in the dispenser case 130 is formed at a position adjacent to the air charged space 160 in the lower part of the dispenser body 110 to penetrate an inside and an outside of the dispenser case 130. Air of predetermined pressure is injected into an inside of the air charged space 160 through the air inlet 131.

The air outlet 132 is provided in a center of a bottom part of the dispenser case 130. The pipe 121 extending from the needle 120 through the air outlet 131 is penetratively coupled to the dispense case 130 and the nozzle 125 coupled to the end of the needle 121 is positioned in the outside of the dispenser case 130, that is, a lower part of the air outlet 131.

As described above, the air injected into the air charged space 160 formed by tightly coupling the dispenser case 130 to the dispenser body 110 through the air inlet 131 is discharged through the air outlet 132 penetratively coupled with the pipe 121. The air discharged through the pipe 121 penetratively coupled with the air outlet 132 removes dregs of the fluid resin 150 remaining on the nozzle 125 on the end of the pipe 125 with flowing.

An operation process of the dispenser 100 in accordance with the embodiment of the invention having the above-described technical configuration will be now described. First, the dregs of the fluid resin 150 remaining on the side and the end of the nozzle 125 are removed by discharging the air through the air outlet 132 formed in the dispenser case 130 before the fluid resin 150 is discharged by applying the predetermined pressure to the resin charging unit 111 of the dispenser body 110.

In other words, as shown in FIG. 1, the nozzle 125 coupled to the end of the needle 120 of the dispenser 100 is positioned on the lens processing surface formed in the center portion of the mold 200 in order to fabricating a wafer lens by a mastering process.

The air is supplied through the air inlet 131 of the dispenser case 130 is sealed with the inner circumference surface of the dispenser case 130 is in close contact with the dispenser body 110 before discharging the fluid resin 150 charged in the dispenser 100 by applying the predetermined pressure by the dispenser 100.

The air supplied through the air inlet 131 passes through the air charged space 160 in the dispenser case 130 and is discharged through the air outlet 132 penetratively coupled with the pipe 121 of the needle 120. The discharged air removes resin dregs leaking and remaining on the nozzle 125 mounted on the end of the needle 120 by air discharge pressure.

At this time, if the pressure of the air discharged through the air outlet 132 is low, the fluid resin dregs are completely removed and if the pressure of the discharged air is too high, the fluid resin 150 in the needle 121 just before discharge is removed by the air flowing the pipe 121 of the needle 120 with the fluid resin dregs. Proper pressure and discharge time of the discharged air should be determined.

As described above, the dispenser for fabricating the wafer lens in accordance with the invention has an advantage that a discharge amount error of the fluid resin can be reduced and an accurate amount of resin can be always discharged by removing the dregs of the fluid resin leaking through the nozzle on the end of the needle coupled to the dispenser body with the air of the predetermined pressure discharged through the air outlet in the bottom part of the dispenser body.

Since a general needle is used as the needle coupled to the dispenser body, the needle can be easily replaced and since a mechanical configuration for precise control of the discharge amount is not required, manufacturing cost of the dispenser can be reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A dispenser comprising:
a dispenser body charged with a fluid resin therein;
a needle coupled to a bottom part of the dispenser body with a nozzle mounted on an end of a pipe extending to a lower part thereof; and
a dispenser case that includes an air inlet and an air outlet in a lower part of a circumference surface and a bottom part of the dispenser body, and is mounted with covering the dispenser.

2. The dispenser as recited in claim 1, wherein the dispenser body includes a resin charging unit formed in a center portion thereof.

3. The dispenser as recited in claim 2, wherein a fluid resin charged in the resin charging unit is made of any one of fluid silicon or resin, a polymer, and the like as a material of an injection molding.

4. The dispenser as recited in claim 1, wherein the needle penetrates the air outlet formed in the bottom part of the dispenser case and the end of the needle protrudes outside of the dispenser case.

5. The dispenser as recited in claim 1, wherein the dispenser case includes an air charged space formed in an inner lower part thereof with an inner circumference surface of the dispenser case being in close contact with an outer circumference surface of the dispenser body.

6. The dispenser as recited in claim 1, wherein dregs of the fluid resin remaining on a side and the end of the nozzle on the end of the needle are removed by air discharged through the air outlet of the dispenser case.
